(19) United States
(12) Patent Application Publication
(10) Pub. No.: US 2025/0039999 A1
(43) Pub. Date: Jan. 30, 2025

(54) INDUCTION HEATING TYPE COOKTOP

(71) Applicant: LG Electronics Inc., Seoul (KR)

(72) Inventors: Chuhyoung CHO, Seoul (KR); Seongho SON, Seoul (KR); Younghwan KWACK, Seoul (KR); Seonho JEON, Seoul (KR); Jongseong JI, Seoul (KR)

(21) Appl. No.: 18/715,944

(22) PCT Filed: May 25, 2022
(86) PCT No.: PCT/KR2022/007458

§ 371 Date: Jun. 3, 2024

(30) Foreign Application Priority Data
Dec. 2, 2021 (KR) 10-2021-0171005

(51) Int. Cl. H05B 6/12

(52) U.S. Cl. CPC H05B 6/1209; H05B 2213/04

(57) ABSTRACT

Provided is an induction heating type cooktop that senses overheating of a thin film to prevent the thin film from being overheated. The induction heating type cooktop includes a case, a cover plate coupled to an upper end of the case and configured to comprise an upper plate, on which an object to be heated is disposed on a top surface thereof, a thin film applied on the upper plate, a working coil configured to generate magnetic fields for heating the object to be heated, and a controller configured to determine whether the thin film is overheated and reduce an output level when the thin film is overheated.

### TECHNICAL FIELD

The present disclosure relates to an induction heating type cooktop. More particularly, the present disclosure relates to an induction heating type cooktop to which a thin film is applied.

### BACKGROUND ART

Various types of cooking appliances are used to heat food at home or in the restaurant. According to the related art, a gas stove using gas as a fuel has been widely used. However, recently, devices for heating an object to be heated, for example, a cooking vessel such as a pot, have been spread using electricity instead of the gas.

A method for heating the object to be heated using electricity is largely divided into a resistance heating method and an induction heating method. The electrical resistance method is a method for heating an object to be heated by transferring heat generated when electric current flows through a metal resistance wire or a non-metallic heating body such as silicon carbide to the object to be heated (e.g., a cooking vessel) through radiation or conduction. In the induction heating method, when high-frequency power having a predetermined intensity is applied to a coil, eddy current is generated in the object to be heated using magnetic fields generated around the coil so that the object to be heated is heated.

Recently, most of the induction heating methods are applied to cooktops.

However, in the case of a cooktop to which the induction heating method is applied, there is a limitation in that only a magnetic body is heated. That is, when a nonmagnetic body (e.g., heat-resistant glass, ceramics, etc.) is disposed on the cooktop, there is a problem that the cooktop to which the induction heating method is applied does not heat the object to be heated.

To solve this problem of such an induction heating type cooktop, the present disclosure intends to use a thin film. Specifically, the cooktop according to the present disclosure may include a thin film to which eddy current is applied so that a nonmagnetic material is heated. In addition, the thin film may have a skin depth thicker than a thickness thereof, and thus, magnetic fields generated by the working coil may pass through the thin film to apply eddy current to the magnetic body, thereby heating the magnetic body.

A temperature of such a thin film may rise to about 500° C. or more. Considering that the thin film may be overheated even when the cooking container is not placed, possibility of safety accidents is high, and thus, a method to prevent this limitation is required.

In addition, if the thin film is overheated at a temperature higher than an expected temperature, it may be damaged, so a method for preventing this is required.

### DISCLOSURE

### Technical Problem

*9Embodiments provide an induction heating type cooktop that senses overheating of a thin film and prevents the thin film from being overheated.

Embodiments also provide an induction heating type cooktop that minimizes the number of temperature sensors for sensing a temperature of a thin film while improving stability of the temperature of the thin film.

Embodiments also provide an induction heating type cooktop that minimizes possibility of safety accidents by preventing overheating of a thin film to prevent the thin film from being damaged.

### Technical Solution

In an induction heating type cooktop according to an embodiment of the present disclosure, a temperature of a thin film is estimated by using thin film characteristics.

An induction heating type cooktop includes a case, a cover plate coupled to an upper end of the case and configured to comprise an upper plate, on which an object to be heated is disposed on a top surface thereof, a thin film applied on the upper plate, a working coil configured to generate magnetic fields for heating the object to be heated, and a controller configured to determine whether the thin film is overheated and reduce an output level when the thin film is overheated.

The controller may be configured to acquire a temperature of the thin film and determine whether the thin film is overheated based on the temperature of the thin film.

The controller may be configured to recognize a thin film temperature estimation value acquired based on an algorithm according to thin film characteristics as the temperature of the thin film.

The induction heating type cooktop may further include a thin film temperature sensor configured to directly sense the temperature of the thin film, wherein the controller may be configured to recognize a thin film temperature sensing value sensed by the thin film temperature sensor as the temperature of the thin film.

The controller may be configured to recognize a higher value of a thin film temperature estimation value acquired based on an algorithm according to thin film characteristics and a thin film temperature sensing value sensed by the thin film temperature sensor as the temperature of the thin film.

The controller may be configured to determine whether the thin film is directly heated, recognize a thin film temperature estimation value acquired based on an algorithm according to thin film characteristics as the temperature of the thin film when the thin film is directly heated, and recognize a thin film temperature sensing value sensed by the thin film temperature sensor as the temperature of the thin film when the thin film is not directly heated.

The controller may be configured to allow the output level to increase when it is determined that the thin film is not overheated in a state in which the output level is reduced due to overheating of the thin film.

The controller may be configured to maintain the output level when the thin film is not overheated, and the output level is not reduced.

The induction heating type cooktop may further include a memory configured to store an algorithm for deriving the temperature of the thin film according to each of a switching frequency, an output, an equivalent inductance, and an equivalent impedance.

An operation method of an induction heating type cooktop, which includes an upper plate, on which an object to be heated is disposed on a top surface thereof, and a thin film applied on the upper plate, includes setting an output level, generating magnetic fields for heating the object to be heated according to the output level, determining whether the thin film is overheated, and reducing the output level when the thin film is overheated.

### Advantageous Effects

According to the embodiment of the present disclosure, the temperature of the thin film may be estimated without using the thin film temperature sensor, and thus, there may be the advantages of sensing whether the thin film is overheated and preventing the overheating.

According to the embodiment of the present disclosure, since the temperature of the thin film is estimated without using the thin film temperature sensor, the number of thin film temperature sensors may be minimized, and thus, there may be the advantages of simplifying the structure and reducing the manufacturing cost.

According to an embodiment of the present disclosure, since the temperature of the thin film is estimated without using the thin film temperature sensor, there may be the advantage of improving the temperature stability of the thin film even if the thin film is non-uniformly overheated.

According to an embodiment of the present disclosure, there may be the advantage of estimate the temperature of the thin film even when the operating frequency is changed.

### DESCRIPTION OF DRAWINGS

FIG. 1 is a view for explaining an induction heating type cooktop according to an embodiment.

FIG. 2 is a cross-sectional view illustrating the induction heating type cooktop and an object to be heated according to an embodiment.

FIG. 3 is a cross-sectional view illustrating an induction heating type cooktop and an object to be heated according to another embodiment.

FIGS. 4 and 5 are views for explaining a relationship between a thickness and a skin depth of a thin film.

FIGS. 6 and 7 are views for explaining a change in impedance between a thin film and an object to be heated according to kinds of objects to be heated.

FIG. 8 is a graph illustrating a change in impedance of a thin film according to a temperature of the thin film.

FIG. 9 is a graph illustrating a change in output of a non-metallic container according to the temperature of the thin film.

FIG. 10 is a block diagram of the induction heating type cooktop according to an embodiment.

FIG. 11 is a flowchart illustrating an operation method of an induction heating type cooktop according to an embodiment.

FIG. 12 is a flowchart illustrating a method for adjusting an output level based on a temperature of thin film in the induction heating type cooktop according to an embodiment.

FIG. 13 is a flowchart illustrating a specific method for acquiring a temperature of the thin film in the induction heating type cooktop according to an embodiment.

### BEST MODE

Hereinafter, preferred embodiments according to the present disclosure will be described in detail with reference to the accompanying drawings. In the drawings, the same reference numerals are used to denote the same or similar elements.

Hereinafter, an induction heating type cooktop according to an embodiment of the present disclosure will be described.

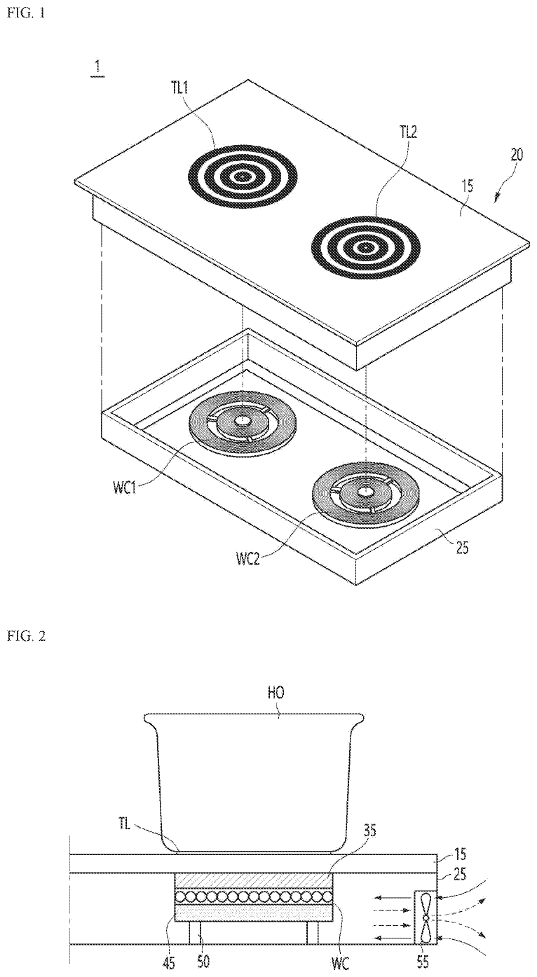

FIG. 1 is a view for explaining an induction heating type cooktop according to an embodiment. FIG. 2 is a cross-sectional view illustrating the induction heating type cooktop and an object to be heated according to an embodiment. FIG. 3 is a cross-sectional view illustrating an induction heating type cooktop and an object to be heated according to another embodiment.

First, referring to FIG. 1, an induction heating type cooktop 1 according to an embodiment of the present disclosure may include a case 25, a cover plate 20, and working coils WC1 and WC2 (i.e., first and second working coils), and thin films TL1 and TL2 (i.e., first and second thin films).

The working coils WC1 and WC2 may be installed in the case 25.

For reference, in the case 25, various devices related to driving of the working coils (for example, a power supply that provides AC power, a bridge diode and capacitor that rectify the AC power of the power supply into DC power, an inverter that converts the rectified DC power into resonance current through a switching operation to provides the resonance current to the working coil, a control module that controls operations of various devices within the induction heating type cooktop 1, a relay or semiconductor switch that turns on or off the working coil, etc.) in addition the working coils WC1 and WC2 may be installed in the case 25, but detailed descriptions thereof will be provided later.

The cover plate 20 may be coupled to an upper end of the case 25 and be provided with an upper plate 15 on which an object to be heated (not shown) is disposed on a top surface thereof.

Specifically, the cover plate 20 may include the upper plate 15 for placing an object to be heated, such as a cooking vessel, thereon.

Here, the upper plate 15 may be made of, for example, a glass material (e.g., ceramics glass).

In addition, the upper plate 15 may be provided with an interface (not shown) that receives an input from a user to transmit the input to a control module (not shown) for an input interface. Of course, the interface may be provided at a position other than the upper plate 15.

For reference, the interface may be a module for inputting a desired heating intensity or driving time of the induction heating type cooktop 1 and may be variously implemented with a physical button or a touch panel. Also, the interface may include, for example, a power button, a lock button, a power level adjustment button (+, −), a timer adjustment button (+, −), a charging mode button, and the like. In addition, the interface may transmit the input received from the user to the control module for the input interface (not shown), and the control module for the input interface may transmit the input to the aforementioned control module (i.e., the control module for the inverter). In addition, the aforementioned control module may control the operations of various devices (e.g., the working coils) based on the input (i.e., a user input) provided from the control module for the input interface.

Whether the working coils WC1 and WC2 are driven and the heating intensity (i.e., thermal power) may be visually displayed on the upper plate 15 in a shape of a crater. The shape of the crater may be indicated by an indicator (not shown) constituted by a plurality of light emitting devices (e.g., LEDs) provided in the case 25.

The working coils WC1 and WC2 may be installed inside the case 25 to heat the object to be heated.

Specifically, the working coil WC may be driven by the aforementioned control module (not shown), and when the object to be heated is disposed on the upper plate 15, the working coil WC may be driven by the control module.

In addition, the working coil WC may directly heat an object to be heated (i.e., a magnetic body) having magnetism and may indirectly heat an object to be used (i.e., a nonmagnetic body) through a thin film TL that will be described later.

In addition, the working coil WC may heat the object to be heated in an induction heating manner and may be provided to overlap the thin film TL in a longitudinal direction (i.e., a vertical direction or an upward and downward direction).

For reference, although the structure in which the two working coils WC1 and WC2 are installed in the case 25 is illustrated in FIG. 1, the embodiment is not limited thereto. That is, one or three or more working coils may be installed in the case 25, but for convenience of explanation, in the embodiment of the present disclosure, the structure in which the two working coils WC1 and WC2 are installed in the case 25 will be described with an example.

The thin film TL may be applied on the upper plate 15 to heat the nonmagnetic body among the objects to be heated. The thin film TL may be inductively heated by the working coil WC.

The thin film TL may be applied on a top surface or a bottom surface of the upper plate 15. For example, as illustrated in FIG. 2, the thin film TL may be applied on the top surface of the upper plate 15, or as illustrated in FIG. 3, the thin film TL may be applied on the bottom surface of the upper plate 15.

The thin film TL may be provided to overlap the working coil WC in the longitudinal direction (i.e., the vertical direction or the upward and downward direction). Thus, the heating of the objects to be heated may be possible regardless of the arrangement positions and types of the objects to be heated.

Also, the thin film TL may have at least one of magnetic and nonmagnetic properties (i.e., a magnetic property, a nonmagnetic property, or both the magnetic and nonmagnetic properties).

In addition, the thin film TL may be made of, for example, a conductive material (e.g., aluminum), and as illustrated in the drawings, a plurality of rings having different diameters may be applied on the upper plate 15 in a repeated shape, but is not limited thereto. That is, the thin film TL may be made of a material other than a conductive material. Also, the thin film TL may be provided in a shape other than the shape in which the plurality of rings having different diameters are repeated.

For reference, although one thin film TL is illustrated in FIGS. 2 and 3, the embodiment is not limited thereto. That is, a plurality of thin films may be applied, but for convenience of description, one thin film TL may be applied as an example.

More details of the thin film TL will be described later.

Next, referring to FIGS. 2 and 3, the induction heating type cooktop 1 according to an embodiment of the present disclosure may further include at least some or all of an insulating material 35, a shielding plate 45, a support member 50, and a cooling fan 55.

The insulating material 35 may be provided between the upper plate 15 and the working coil WC.

Specifically, the insulating material 35 may be mounted under the upper plate 15, and the working coil WC may be disposed below the insulating material 35.

The insulating material 35 may prevent heat generated while the thin film TL or the object HO to be heated by the driving of the working coil WC from being transmitted to the working coil WC.

That is, when the thin film TL or the object HO to be heated is heated by electromagnetic induction of the working coil WC, the heat of the thin film TL or the object HO to be heated may be transferred to the upper plate 15, and then, the heat of the upper plate 15 may be transferred to the working coil WC again to damage the working coil WC.

The insulating material 35 may block the heat transferred to the working coil WC as described above to prevent the working coil WC from being damaged by the heat, and furthermore, prevent heating performance of the working coil WC from being deteriorated.

For reference, although it is not an essential component, a spacer (not shown) may be installed between the working coil WC and the insulating material 35.

Specifically, the spacer (not shown) may be inserted between the working coil WC and the insulating material 35 so that the working coil WC and the insulating material 35 are not in directly contact with each other. Thus, the spacer (not shown) may prevent the heat generated while the thin film TL or the object HO to be heated by the driving of the working coil WC from being transmitted to the working coil WC through the insulating material 35.

That is, since the spacer (not shown) partially shares the role of the insulating material 35, a thickness of the insulating material 35 may be minimized, and thus, an interval between the object HO to be heated and the working coil WC may be minimized.

In addition, the spacer (not shown) may be provided in plurality, and the plurality of spacers may be disposed to be spaced apart from each other between the working coil WC and the insulating material 35. Thus, air suctioned into the case 25 by a cooling fan 55 to be described later may be guided to the working coil WC by the spacers.

That is, the spacers may guide the air introduced into the case 25 by the cooling fan 55 so as to be properly transferred to the working coil WC, thereby improving cooling efficiency of the working coil WC.

The shielding plate 45 may be mounted on the bottom surface of the working coil WC to block magnetic fields generated downward when the working coil WC is driven.

Specifically, the shielding plate 45 may block the magnetic fields generated downward when the working coil WC is driven and may be supported upward by the support member 50.

The support member 50 may be installed between a bottom surface of the shielding plate 45 and the lower plate of the case 25 to support the shielding plate 45 upward.

Specifically, the support member 50 may support the shielding plate 45 upward to indirectly support the insulating material 35 and the working coil WC upward, and thus, the insulating material 35 may be in close contact with the upper plate 15.

As a result, the interval between the working coil WC and the object HO to be heated may be constantly maintained.

For reference, the support member 50 may include, for example, an elastic body (e.g., a spring) for supporting the shielding plate 45 upward, but is not limited thereto. In addition, since the support member 50 is not an essential component, the support member 50 may be omitted from the induction heating type cooktop 1.

The cooling fan 55 may be installed inside the case 25 to cool the working coil WC.

Specifically, the cooling fan 55 may be controlled to be driven by the above-described control module and may be installed on a sidewall of the case 25. Of course, the cooling fan 55 may be installed at a position other than the sidewall of the case 25, but in the present disclosure, for convenience of explanation, the structure in which the cooling fan 55 is installed on the sidewall of the case 25 will be described as an example.

In addition, as illustrated in FIGS. 2 and 3, the cooling fan 55 may suction air from the outside of the case 25 to deliver the air to the working coil WC or may suction air (particularly, heated air) inside the case 25 to discharge the air to the outside of the case 25.

As a result, efficient cooling of the components (in particular, the working coil WC) inside the case 25 is possible.

Also, as described above, the air outside the case 25 delivered to the working coil WC by the cooling fan 55 may be guided to the working coil WC by the spacers. Thus, the direct and efficient cooling of the working coil WC is possible to improve durability of the working coil WC (i.e., improvement in durability due to prevention of thermal damage).

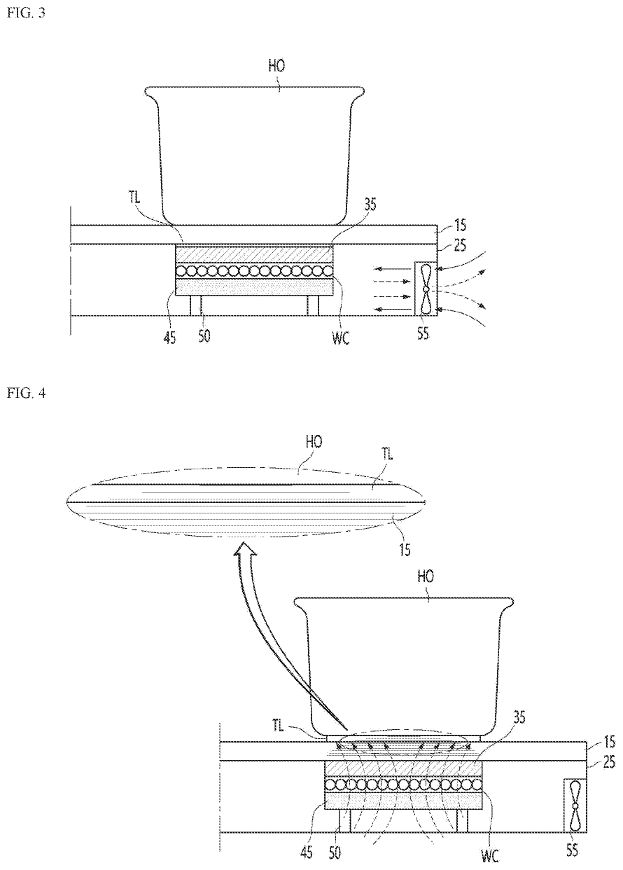

As described above, the induction heating type cooktop 1 according to an embodiment of the present disclosure may have the above-described characteristics and configuration. Hereinafter, characteristics and configuration of the thin film described above in more detail will be described with reference to FIGS. 4 to 7.

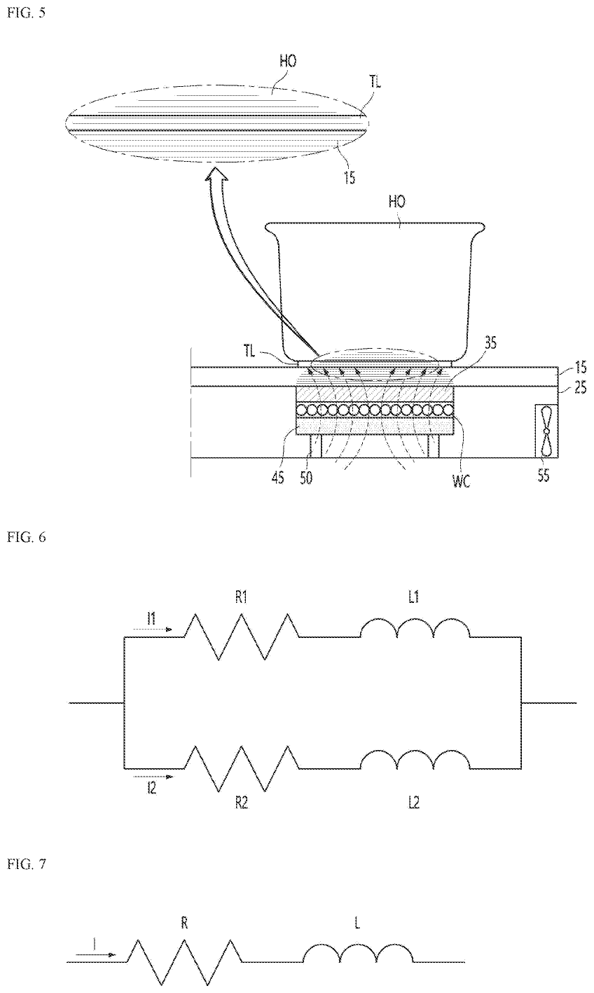

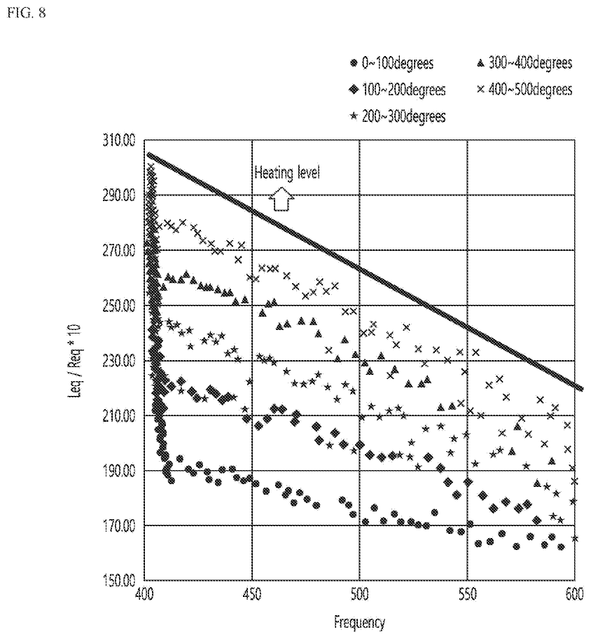

FIGS. 4 and 5 are views for explaining a relationship between a thickness and a skin depth of a thin film. FIGS. 6 and 7 are views for explaining a change in impedance between the thin film and the object to be heated according to kinds of objects to be heated.

The thin film TL may be made of a material having low relative permeability.

Specifically, since the relative permeability of the thin film TL is low, a skin depth of the thin film TL may be deep. Here, the skin depth may mean a current penetration depth from a surface of the material, and the relative permeability may be inversely proportional to the skin depth. Thus, as the relative permeability of the thin film TL decreases, the skin depth of the thin film TL increases.

Also, the skin depth of the thin film TL may be thicker than the thickness of the thin film TL. That is, the thin film TL may have a thin thickness (e.g., about 0.1 μm to about 1,000 μm thickness), and the skin depth of the thin film TL may be deeper than the thickness of the thin film TL. As a result, as the magnetic fields generated by the working coil WC passes through the thin film TL and are transmitted to the object HO to be heated, eddy current may be induced in the object HO to be heated.

That is, as illustrated in FIG. 4, when the skin depth of the thin film TL is shallower than the thickness of the thin film TL, it may be difficult to allow the magnetic fields generated by the working coil WC to reach the object HO to be heated.

However, as illustrated in FIG. 5, when the skin depth of the thin film TL is greater than the thickness of the thin film TL, the magnetic fields generated by the working coil WC may reach the object HO to be heated. That is, in an embodiment of the present disclosure, since the skin depth of the thin film TL is greater than the thickness of the thin film TL, the magnetic fields generated by the working coil WC may pass through the thin film TL and then be mostly transferred to the object HO to be heated and thus may be consumed. As a result, the object HO to be heated may be mainly heated.

Since the thin film TL has a thin thickness as described above, the thin film TL may have a resistance value that may be heated by the working coil WC.

Specifically, the thickness of the thin film TL may be inversely proportional to the resistance value (i.e., surface resistance value) of the thin film TL. That is, as the thickness of the thin film TL applied on the upper plate 15 is thinner, the resistance value (i.e., surface resistance value) of the thin film TL may increase, and thus, the thin film TL may be thinly applied on the upper plate 15 and be changed in characteristic to loads that may be heated.

For reference, the thin film TL may have a thickness of, for example, about 0.1 μm to about 1,000 μm, but is not limited thereto.

The thin film TL having such characteristics may be present to heat the nonmagnetic body, and thus, impedance characteristics between the thin film TL and the object HO to be heated may be changed according to whether the object to be heated HO disposed on the upper plate 15 is a magnetic body or nonmagnetic body.

First, the case in which the object HO to be heated is the magnetic body will be described as follows.

When the magnetic object HO to be heated is disposed on the upper plate 15, and the working coil WC is driven, a resistance component R1 and an inductor component L1 of the object HO to be heated, which has the magnetism as illustrated in FIG. 6) may form an equivalent circuit with a resistance component R2 and an inductor component L2 of the thin film TL.

In this case, the impedance (i.e., impedance measured by R1 and L1) of the object HO to be heated, which has the magnetism, in the equivalent circuit may be less than that of the thin film TL (i.e., the impedance measured by R2 and L2).

Thus, when the equivalent circuit as described above is formed, magnitude of the eddy current I1 applied to the magnetic object HO to be heated may be greater than that of the eddy current I2 applied to the thin film TL. Thus, most of the eddy current generated by the working coil WC may be applied to the object HO to be heated, and thus, the object HO to be heated may be heated.

That is, when the object HO to be heated is the magnetic body, the above-described equivalent circuit may be formed, and thus, most of the eddy current may be applied to the object HO to be heated. As a result, the working coil WC may directly heat the object HO to be heated.

Of course, some eddy current may be also applied to the thin film TL to slightly heat the thin film TL, and thus, the object HO to be heated may be indirectly slightly heated by the thin film TL. In this case, the working coil WC may be a main heating source, and the thin film TL may be a secondary heating source. However, when compared to a degree of direct heating of the object HO by the working coil WC, a degree of indirect heating of the object HO by the thin film TL may not be significant.

Next, the case in which the object to be heated is the nonmagnetic body will be described as follows.

When the object HO to be heated, which does not have the magnetism, is disposed on the upper plate 15, and the working coil WC is driven, there is no impedance in the nonmagnetic object HO to be heated, and the thin film TL may have an impedance. That is, the resistance component R and the inductor component L may exist only in the thin film TL.

Therefore, when the nonmagnetic object HO to be heated is disposed on the upper plate 15 and the working coil WC is driven, as illustrated in FIG. 7, the resistance component R and the inductor component L of the thin film TL may form an equivalent circuit.

Thus, eddy current I may be applied only to the thin film TL, and eddy current may not be applied to the object HO to be heated, which does not have magnetism. More specifically, the eddy current I generated by the working coil WC may be applied only to the thin film TL, and thus, the thin film TL may be heated.

That is, when the object HO to be heated is the nonmagnetic body, as described above, the eddy current I may be applied to the thin film TL to heat the thin film TL, and the object HO to be heated, which does not have magnetism, may be indirectly heated by the thin film TL heated by the working coil WC. In this case, the thin film TL may be a main heating source.

In summary, the object HO to be heated may be directly or indirectly heated by a single heat source, which is called the working coil WC, regardless of whether the object HO is the magnetic body or the nonmagnetic body. That is, when the object HO to be heated is the magnetic body, the working coil WC may directly heat the object HO to be heated, and when the object HO to be heated is the nonmagnetic body, the thin film TL heated by the working coil WC may indirectly heat the object HO to be heated.

As described above, the induction heating type cooktop 1 according to the embodiment of the present disclosure may heat both the magnetic body and the nonmagnetic body, regardless of the arrangement position and type of the object HO to be heated HO. Thus, the user may place the object to be heated on any heating area on the top plate 15 without needing to determine whether the object HO is the magnetic body or the nonmagnetic body, thereby improving ease of use.

In addition, the induction heating type cooktop 1 according to an embodiment of the present disclosure may directly or indirectly heat the object to be heated with the same heat source, and thus, there is no need to provide a separate heating plate or a radiator heater. Thus, it is possible to not only improve heating efficiency but also reduce material costs.

The induction heating type cooktop 1 according to an embodiment of the present disclosure may estimate a temperature of the thin film TL. The induction heating type cooktop 1 may estimate the temperature of the thin film TL by using the characteristics of the thin film TL.

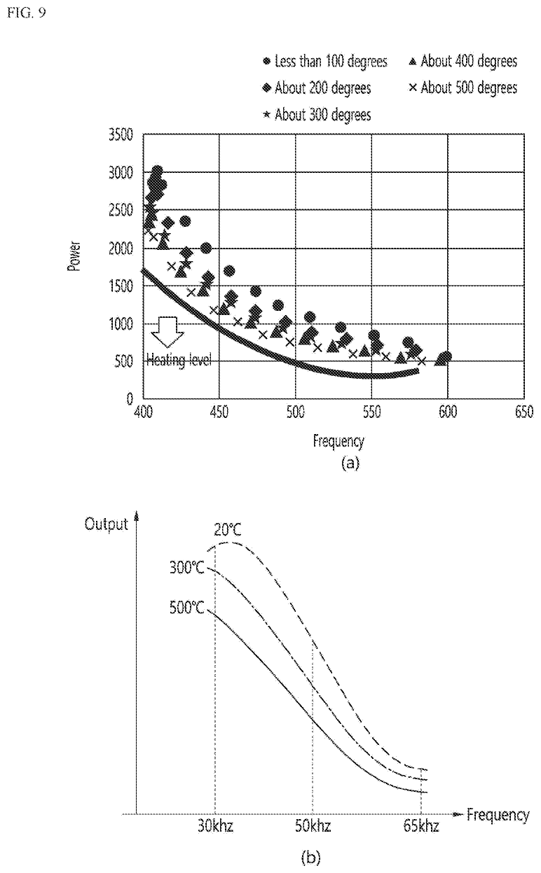

For this, an experiment or simulation for identifying the characteristics of the thin film TL may be performed in advance, and the results are illustrated in FIGS. 8 and 9. FIGS. 8 and 9 illustrate results obtained by measuring a change in impedance according to the temperature of the thin film and a change in output to a non-metallic container through an experiment or simulation while the thin film TL is directly heated.

FIG. 8 is a graph illustrating a change in impedance of a thin film according to a temperature of the thin film.

Specifically, in FIG. 8, an x-axis indicates a switching frequency, and a y-axis indicates a value obtained by multiplying a value obtained by dividing the combined inductance by the combined impedance (combined resistance) by 10.

Referring to FIG. 8, it is shown that a Y value increases as the temperature of the thin film TL increases, which means that as the temperature of the thin film TL increases, the combined impedance decreases. Moreover, since the Y value increases as the temperature of the thin film TL rises even though the molecule multiplies the combined inductance by 10, it is seen that the change in combined impedance compared to the change in combined inductance is very large.

FIG. 9 is a graph illustrating a change in output of the non-metallic container according to the temperature of the thin film.

Specifically, (a) of FIG. 9 illustrates results of experimenting a change in output of the thin film to the non-metallic container according to the temperature of the thin film, and (b) of FIG. 9 illustrates results of simulating a change in output the non-metallic container according to the temperature of the thin film. In each of (a) and (b) of FIG. 9, an x-axis indicates a switching frequency, and a y-axis indicates an output (power).

Referring to FIG. 9, the higher the temperature of the thin film TL, the lower the output to the non-metallic container. As the temperature increases while the thin film TL is heated, the output decreases. To compensate for this phenomenon, the cooktop 1 may have a lower switching frequency.

Due to the experimental and simulation results illustrated in FIGS. 8 and 9, a relationship between a switching frequency, an output, an equivalent inductance, and an equivalent impedance according to the temperature of the thin film TL may be derived. The induction heating type cooktop 1 may store in advance an algorithm for deriving the temperature of the thin film according to each of the switching frequency, the output, the equivalent inductance, and the equivalent impedance.

That is, the induction heating type cooktop 1 may estimate the temperature of the thin film according to the switching frequency, the output, the equivalent inductance, and the equivalent impedance through the previously stored algorithm.

In addition, the induction heating type cooktop 1 may uses the previously stored algorithm to estimate the change in temperature of the thin film according to the change in switching frequency, output, equivalent inductance or equivalent impedance, and may compare the change in temperature of the thin film to the change in actual temperature of the thin film to determine whether the thin film TL is directly heated.

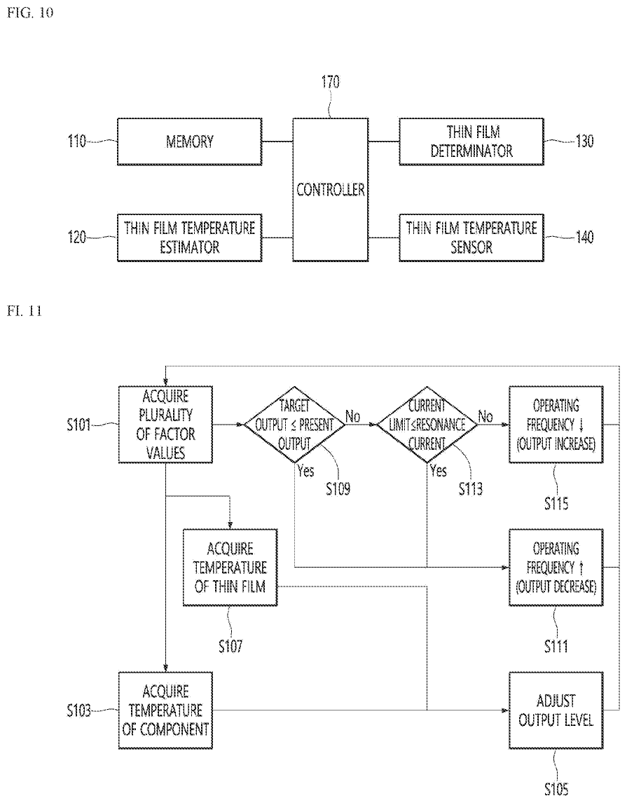

FIG. 10 is a block diagram of the induction heating type cooktop according to an embodiment.

The induction heating type cooktop 1 according to an embodiment of the present disclosure may include at least some or all of a memory 110, a thin film temperature estimator 120, a thin film determinator 130, a thin film temperature sensor 140, and a controller 170.

The memory 110 may store an algorithm for estimating the temperature of the thin film according to at least one or all of the switching frequency, the output, the equivalent inductance, or the equivalent impedance. This algorithm may be stored in advance when the cooktop 1 is manufactured. Also, the algorithm may be updated even after the cooktop 1 is manufactured. The algorithm may be stored in various forms, such as functions and tables.

The thin film temperature estimator 120 may acquire at least one of an input voltage, an input current, or a switching frequency. According to an embodiment, the thin film temperature estimator 120 may include a sensing unit (not shown) for sensing at least one of the input voltage, the input current, or the switching frequency.

The thin film temperature estimator 120 may calculate an output, an equivalent inductance, and an equivalent impedance by using the input voltage, the input current, or the switching frequency. In addition, the thin film temperature estimator 120 may estimate the temperature of the thin film by applying the calculated output, equivalent inductance, and equivalent impedance to the algorithm stored in the memory 110.

The thin film determinator 130 may determine whether the thin film TL is being directly heated. When an object HO to be heated, which has the magnetism is placed on the upper plate 15, the working coil WC may directly heat the object HO to be heated. Here, the thin film TL may not be heated or may be indirectly heated. On the other hand, when the object HO to be heated, which is the non-metallic material such as weak magnetic metal or glass is placed on the upper plate 15, the working coil WC may directly heat the thin film TL, and the object HO to be heated may be heated by the thin film TL. Even when the object HO to be heated is not placed on the upper plate 15, the thin film TL may be directly heated.

The thin film determinator 130 may estimate a change in temperature of the thin film according to a change in switching frequency, output, equivalent inductance, or equivalent impedance by using the algorithm stored in the memory 110. In addition, the thin film determinator 130 may acquire a change in actual temperature of the thin film TL based on sensing information of the thin film temperature sensor 140.

The thin film determinator 130 may determine whether the thin film TL is being directly heated by comparing the estimated change in temperature of the thin film to the change in actual temperature of the thin film TL. The thin film determinator 130 may determine that the thin film TL is being directly heated if the estimated change in temperature of the thin film and the change in actual temperature of the thin film TL are similar to each other. If the estimated change in temperature of the thin film and the change in actual temperature of the thin film TL are not similar to each other, it may be determined that the thin film TL is not directly heated.

For example, when a difference between the estimated temperature of the thin film the actual temperature of the thin film TL over time is maintained within a predetermined value, the thin film determinator 130 may determine that the change in estimated temperature of the thin film and the change in actual temperature of the thin film TL are similar to each other. However, this is merely an example, and the method for determining whether the change in estimated temperature of the thin film and the change in actual temperature of the thin film TL by the thin film determinator 130 are similar to each other may vary.

The thin film temperature sensor 140 may sense the actual temperature of the thin film TL by sensing the temperature of the thin film TL.

Since the thin film temperature sensor 140 senses a temperature at one point of the thin film TL, when the thin film TL is heated non-uniformly, it is difficult to accurately sense the temperature of the thin film TL. In particular, when overheating occurs at another point that is not sensed by the thin film temperature sensor 140, it is difficult to sense the overheating of the thin film TL by the thin film temperature sensor 140.

Thus, the controller 170 may determine whether the thin film TL is overheated based on the estimated temperature of the thin film and the actual temperature of the thin film, which are sensed by the thin film temperature sensor 140, and when it is determined that the thin film TL is overheated, the controller 170 may control the components of the cooktop 1 so that the temperature of the thin film TL is lowered.

The controller 170 may control at least one of the memory 110, the thin film temperature estimator 120, the thin film determinator 130, or the thin film temperature sensor 140.

FIG. 11 is a flowchart illustrating an operation method of an induction heating type cooktop according to an embodiment.

A controller 170 may acquire a plurality of factor values (S101).

Here, the plurality of factor values may be values used for estimating the temperature of the thin film TL and may include at least one of an input voltage, an input current, a resonance current, or an operating frequency (switching frequency). The controller 170 may acquire at least one of the input voltage, the input current, the resonance current, or the switching frequency through the thin film temperature estimator 120. In addition, the controller 170 may acquire an output, an equivalent impedance, and an equivalent inductance by using the input voltage, the input current, and the resonance current. That is, the plurality of factor values may further include the output, the equivalent impedance, and the equivalent inductance.

The controller 170 may acquire at least one of the input voltage, the input current, the resonance current, the operating frequency (switching frequency), the output, the equivalent impedance, or the equivalent inductance as the plurality of factor values.

Also, the controller 170 may acquire at least one temperature as the plurality of factor values. Here, the temperature may include a temperature sensed through at least one sensor provided in the cooktop 1. For example, the controller 170 may acquire a temperature of a switching element (e.g., IGBT), a temperature of a bridge diode, or a temperature of the thin film TL.

The controller 170 may acquire temperatures of the components (S103).

The controller 170 may acquire temperature of various components such as the switching element and the bridge diode among the plurality of factor values.

The controller 170 may adjust an output level based on the component temperature (S105).

When the component temperature is higher than a preset threshold temperature, the controller 170 may reduce the output level to prevent the component from being overheated.

The controller 170 may determine whether a current output is equal to or greater than a target output (S109).

When the current output is equal to or greater than the target output, the controller 170 may allow the operating frequency to increase (S111).

That is, when the current output is equal to or greater than the target output, the controller 170 may allow the operating frequency to increase, thereby reducing the output.

When the current output is less than the target output, the controller 170 may determine whether the resonance current is equal to or greater than a current limit (S113).

The current limit may be maximum current set to ensure operation stability of the cooktop 1.

When the resonance current is equal to or greater than the current limit, the controller 170 may allow the operating frequency to increase (S111).

That is, when the resonance current is equal to or greater than the current limit, the controller 170 may allow the operating frequency to increase, thereby reducing the output.

When the resonance current is less than the current limit, the controller 170 may allow the operating frequency to decrease (S115).

When the resonance current is less than the current limit, the controller 170 may allow the output to decrease, thereby reducing the operating frequency. As a result, the current output may reach the target output.

In the present disclosure, to prevent the thin film TL from being overheated, the operation S107 of FIG. 11 and the process of adjusting the output level according to the operation S107 may be further performed.

Specifically, the controller 170 may acquire the temperature of the thin film (S107) and adjust the output level based on the temperature of the thin film (S105).

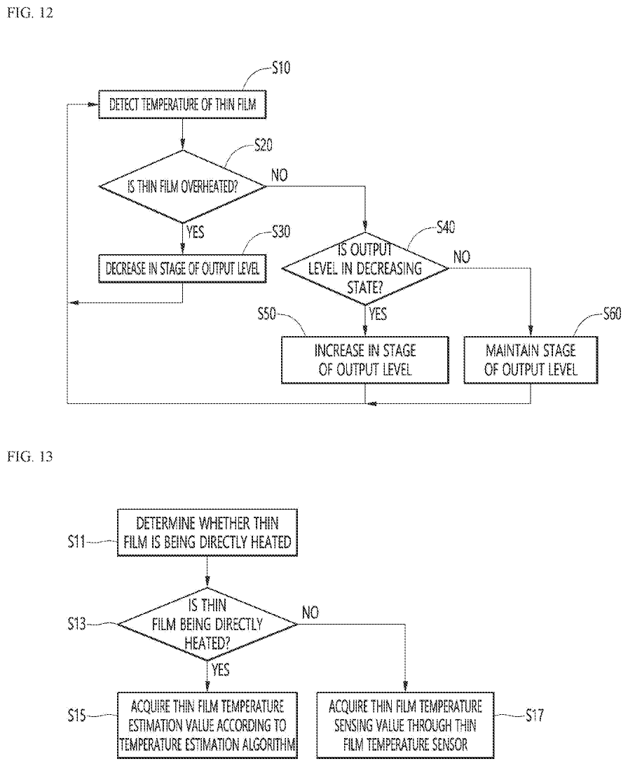

That is, the controller 170 may acquire the temperature of the thin film TL based on the plurality of factor values and adjust the output level based on the temperature of the thin film. This will be described in detail with reference to FIGS. 12 to 13.

FIG. 12 is a flowchart illustrating a method for adjusting an output level based on a temperature of thin film in the induction heating type cooktop according to an embodiment.

First, referring to FIG. 12, a controller 170 may sense a temperature of the thin film TL (S10).

FIG. 13 is a flowchart illustrating a specific method for acquiring a temperature of the thin film in the induction heating type cooktop according to an embodiment. FIG. 13 is a flowchart in which the operation S10 is embodied.

A method for sensing a temperature of the thin film TL will be described in detail with reference to FIG. 13.

The controller 170 may determine whether the thin film TL is being directly heated (S11).

*160When it is determined that the thin film TL is being directly heated, the controller 170 may acquire an estimated temperature of the thin film according to a temperature estimation algorithm (S15).

The temperature estimation algorithm may be an algorithm stored in the memory 110. When it is determined that the thin film TL is being directly heated, the controller 170 may acquire the thin film temperature estimation value through the algorithm stored in the memory 110.

When it is determined that the thin film TL is not being directly heated, the controller 170 may acquire a thin film temperature sensing value through the thin film temperature sensor 140 (S17).

That is, when it is determined that the thin film TL is not directly heated, the controller 170 may acquire the thin film temperature sensing value sensed by the thin film temperature sensor 140.

The thin film temperature estimation value or the thin film temperature sensing value acquired in FIG. 13 may be recognized as the temperature of the thin film TL.

According to another embodiment of the present disclosure, a controller 170 may acquire a thin film temperature estimation value and a thin film temperature sensing value regardless of whether the thin film TL is directly heated and may recognize a higher value among the thin film temperature estimation value and the thin film temperature sensing value as the temperature of the thin film TL. In this case, there is an advantage in that stability of the thin film temperature is improved.

FIG. 12 will be described again.

According to the above-described embodiments, the controller 170 may recognize the thin film temperature estimation value or the thin film temperature sensing value as the temperature of the thin film TL.

The controller 170 may determine whether the thin film is overheated (S20).

The controller 170 may determine whether the thin film TL is overheated based on the temperature of the thin film.

When it is determined that the thin film TL is overheated, the controller 170 may allow a stage of an output level to decrease (S30).

When it is determined that the thin film TL is not overheated, the controller 170 may determine whether the output level decreases (S40).

Here, the state in which the output level decreases may mean a state in which the stage of the output level decreases due to the overheating of the thin film TL.

When it is determined that the output level is in the decreasing state, the controller 170 may allow the stage of the output level to increase (S50).

That is, when it is determined that the thin film TL is not overheated after the controller 170 allows a stage of a set output level to decrease due to the overheating of the thin film TL, it is possible to increase in stage of the output level to the set output level again.

When the output level is not in the decreasing state, the controller 170 may maintain the stage of the output level (S60).

Through the operation method as illustrated in FIGS. 12 and 13, the induction heating type cooktop 1 may prevent the thin film TL from being overheated.

The above-disclosed subject matter is to be considered illustrative, and not restrictive, and the appended claims are intended to cover all such modifications, enhancements, and other embodiments, which fall within the true spirit and scope of the present disclosure.

Thus, the embodiment of the present disclosure is to be considered illustrative, and not restrictive, and the technical spirit of the present disclosure is not limited to the foregoing embodiment.

Therefore, the scope of the present disclosure is defined not by the detailed description of the invention but by the appended claims, and all differences within the scope will be construed as being included in the present disclosure.

1. An induction heating type cooktop comprising:
a case;
a cover plate coupled to an upper end of the case and configured to comprise an upper plate, on which an object to be heated is disposed on a top surface thereof;
a thin film applied on the upper plate;
a working coil configured to generate magnetic fields for heating the object to be heated; and
a controller configured to determine whether the thin film is overheated and reduce an output level when the thin film is overheated.

2. The induction heating type cooktop according to claim 1, wherein the controller is configured to acquire a temperature of the thin film and determine whether the thin film is overheated based on the temperature of the thin film.

3. The induction heating type cooktop according to claim 2, wherein the controller is configured to recognize a thin film temperature estimation value acquired based on an algorithm according to thin film characteristics as the temperature of the thin film.

4. The induction heating type cooktop according to claim 2, further comprising a thin film temperature sensor configured to directly sense the temperature of the thin film,
wherein the controller is configured to recognize a thin film temperature sensing value sensed by the thin film temperature sensor as the temperature of the thin film.

5. The induction heating type cooktop according to claim 2, wherein the controller is configured to recognize a higher value of a thin film temperature estimation value acquired based on an algorithm according to thin film characteristics and a thin film temperature sensing value sensed by the thin film temperature sensor as the temperature of the thin film.

6. The induction heating type cooktop according to claim 2, wherein the controller is configured to:
determine whether the thin film is directly heated;
recognize a thin film temperature estimation value acquired based on an algorithm according to thin film characteristics as the temperature of the thin film when the thin film is directly heated; and
recognize a thin film temperature sensing value sensed by the thin film temperature sensor as the temperature of the thin film when the thin film is not directly heated.

7. The induction heating type cooktop according to claim 1, wherein the controller is configured to allow the output level to increase when it is determined that the thin film is not overheated in a state in which the output level is reduced due to overheating of the thin film.

8. The induction heating type cooktop according to claim 1, wherein the controller is configured to maintain the output level when the thin film is not overheated, and the output level is not reduced.

9. The induction heating type cook-top according to claim 1, further comprising a memory configured to store an algorithm for deriving the temperature of the thin film according to each of a switching frequency, an output, an equivalent inductance, and an equivalent impedance.

10. An operation method of an induction heating type cooktop, which comprises an upper plate, on which an object to be heated is disposed on a top surface thereof, and a thin film applied on the upper plate, the operation method comprising:
setting an output level;
generating magnetic fields for heating the object to be heated according to the output level;
determining whether the thin film is overheated; and
reducing the output level when the thin film is overheated.
